(19) United States
(12) Patent Application Publication
(10) Pub. No.: US 2026/0299939 A1
(43) Pub. Date: Oct. 1, 2026

(54) METHOD AND SYSTEM FOR GENERATING CUSTOMIZED DOCUMENTATION OF LEGACY SOURCE CODES

(71) Applicant: The Capital Markets Company, LLC, New York, NY (US)

(72) Inventors: Gerhardt Jacobus SCRIVEN, Indaiatuba (BR); Marcel Aurelio ALVES DE ARAUJO BRAGA, Sao Paulo (BR); Maikon Lucian LENZ, Cascavel (BR)

(73) Assignee: The Capital Markets Company, LLC, New York, NY (US)

(21) Appl. No.: 19/256,674

(22) Filed: Jul. 1, 2025

Related U.S. Application Data
(60) Provisional application No. 63/780,157, filed on Mar. 28, 2025.

(51) Int. Cl. G06F 8/73

(52) U.S. Cl. CPC G06F 8/73

(57) ABSTRACT

Disclosed herein, method and system for generating customized documentation of legacy source codes. The method may include creating a semantic network based on a legacy source code through pattern identification of the legacy source code using a deterministic crawler. The method may further include generating an enriched semantic network from the semantic network based on an input reference taxonomy in response to a network enrichment prompt. The method may further include generating one or more transcripts for the enriched semantic network using a deterministic technique. The method may further include generating a documentation file of the legacy source code for each of a set of personas based on the one or more transcripts in response to a persona-specific documentation prompt. The persona-specific documentation prompt may include the one or more transcripts, a predefined persona-specific prompt template, and a set of documentation instructions.

### TECHNICAL FIELD

This disclosure generally relates to source code documentation. More particularly, the disclosure relates to a method and system for generating customized documentation of legacy source codes.

### BACKGROUND

For legacy application modernization, reverse engineering of legacy application portfolios (such as Jobs, Cobol programs, DB2 and VSAM data definitions, CICS maps, and Copybooks) requires extracting knowledge tailored to specific and configurable IT personas. Thus, for same hundreds of thousands of lines of code need to be explained differently to each IT persona, providing the IT personas with only the information relevant to the respective roles.

Traditional documentation methods fall short in addressing the diverse needs of different stakeholders (i.e., the IT personas), such as developers, testers, project managers, business analysts and the like. The traditional documentation methods typically provide a one-size-fits-all documentation that lack the specificity required by the various stakeholders involved in the software lifecycle. For instance, the testers need documentation that highlights test cases, expected outcomes, and edge cases. The project managers require insights into project timelines, dependencies, and risk factors. The business analysts, on the other hand, seek documentation that aligns with business processes, user stories, and functional requirements.

Thus, in the traditional documentation methods, the stakeholders spend excessive time deciphering technical documentation to extract relevant information, leading to delays and reduced productivity. Additionally, the lack of tailored documentation increases the risk of miscommunication and misunderstandings among team members, resulting in errors and rework. Furthermore, new or existing team members unfamiliar with the legacy codebase struggle to gain a comprehensive understanding, hindering their ability to contribute effectively. Moreover, as different stakeholders attempt to document their findings independently, the documentation becomes fragmented and inconsistent, further complicating the maintenance process.

The techniques in the present state of art fail to provide tailored knowledge from legacy source codes for different IT personas. There is, therefore, a need for a technique to provide specific documentation corresponding to the role.

### SUMMARY

In one embodiment, a method for generating customized documentation of legacy source codes is disclosed. The method may include creating a semantic network based on a legacy source code through pattern identification of the legacy source code using a deterministic crawler. The method may further include generating, via a Large Language Model (LLM), an enriched semantic network from the semantic network based on an input reference taxonomy in response to a network enrichment prompt. The enriched semantic network may include a mapping between the semantic network and the input reference taxonomy. The network enrichment prompt may include the semantic network, the input reference taxonomy, and a set of network enrichment instructions. The input reference taxonomy may include a hierarchical arrangement of a plurality of source code functionalities. The method may further include generating one or more transcripts for the enriched semantic network using a deterministic technique. Each of the one or more transcripts may be a natural language description of the enriched semantic network based on a predefined context. The method may further include generating, via the LLM, a documentation file of the legacy source code for each of a set of personas based on the one or more transcripts in response to a persona-specific documentation prompt. The persona-specific documentation prompt may include the one or more transcripts, a predefined persona-specific prompt template, and a set of documentation instructions.

In another embodiment, a system for generating customized documentation of legacy source codes is disclosed. The system may include a processor, and a memory communicatively coupled to the processor. The memory may store processor-executable instructions, which, on execution, may cause the processor to create a semantic network based on a legacy source code through pattern identification of the legacy source code using a deterministic crawler. The stored processor-executable instructions, on execution, may further cause the processor to generate, via a Large Language Model (LLM), an enriched semantic network from the semantic network based on an input reference taxonomy in response to a network enrichment prompt. The enriched semantic network may include a mapping between the semantic network and the input reference taxonomy. The network enrichment prompt may include the semantic network, the input reference taxonomy, and a set of network enrichment instructions. The input reference taxonomy may include a hierarchical arrangement of a plurality of source code functionalities. The stored processor-executable instructions, on execution, may further cause the processor to generate one or more transcripts for the enriched semantic network using a deterministic technique. Each of the one or more transcripts may be a natural language description of the enriched semantic network based on a predefined context. The stored processor-executable instructions, on execution, may further cause the processor to generate, via the LLM, a documentation file of the legacy source code for each of a set of personas based on the one or more transcripts in response to a persona-specific documentation prompt. The persona-specific documentation prompt may include the one or more transcripts, a predefined persona-specific prompt template, and a set of documentation instructions.

In yet another embodiment, a non-transitory computer-readable medium storing computer-executable instructions for generating customized documentation of legacy source codes is disclosed. The stored instructions, when executed by a processor, may cause the processor to perform operations including creating a semantic network based on a legacy source code through pattern identification of the legacy source code using a deterministic crawler. The operations may further include generating, via a Large Language Model (LLM), an enriched semantic network from the semantic network based on an input reference taxonomy in response to a network enrichment prompt. The enriched semantic network may include a mapping between the semantic network and the input reference taxonomy. The network enrichment prompt may include the semantic network, the input reference taxonomy, and a set of network enrichment instructions. The input reference taxonomy may include a hierarchical arrangement of a plurality of source code functionalities. The operations may further include generating one or more transcripts for the enriched semantic network using a deterministic technique. Each of the one or more transcripts may be a natural language description of the enriched semantic network based on a predefined context. The operations may further include generating, via the LLM, a documentation file of the legacy source code for each of a set of personas based on the one or more transcripts in response to a persona-specific documentation prompt. The persona-specific documentation prompt may include the one or more transcripts, a predefined persona-specific prompt template, and a set of documentation instructions.

### BRIEF DESCRIPTION OF DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating customized documentation of legacy source codes, in accordance with some embodiments of the present disclosure.

FIG. 2 illustrates a functional block diagram of an exemplary system for generating customized documentation of legacy source codes, in accordance with some embodiments of the present disclosure.

FIG. 3 illustrates a flow diagram of an exemplary method for generating customized documentation of legacy source codes, in accordance with some embodiments of the present disclosure.

FIG. 4 illustrates a flow diagram of an exemplary method for creating a semantic network based on a legacy source code, in accordance with some embodiments of the present disclosure.

FIG. 5 illustrates a flow diagram of an exemplary method for generating an enriched semantic network, in accordance with some embodiments of the present disclosure.

FIG. 6 illustrates a flow diagram of an exemplary method for generating a documentation file of a legacy source code for a persona, in accordance with some embodiments of the present disclosure.

FIG. 7 illustrates a flow diagram of an exemplary method for generating persona-specific source code documentation, in accordance with some embodiments of the present disclosure.

FIG. 8 illustrates an exemplary set of items for COBOL, in accordance with some embodiments of the present disclosure.

FIG. 9 illustrates a schematic diagram of an exemplary business taxonomy, in accordance with some embodiments of the present disclosure.

FIG. 10 illustrates an exemplary semantic network, in accordance with some embodiments of the present disclosure.

FIG. 11 illustrates an exemplary enriched semantic network, in accordance with some embodiments of the present disclosure.

FIG. 12 is a flow diagram for a detailed exemplary method for generating persona-specific documentation files of a legacy source code for a set of personas, in accordance with some embodiments of the present disclosure.

FIG. 13 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

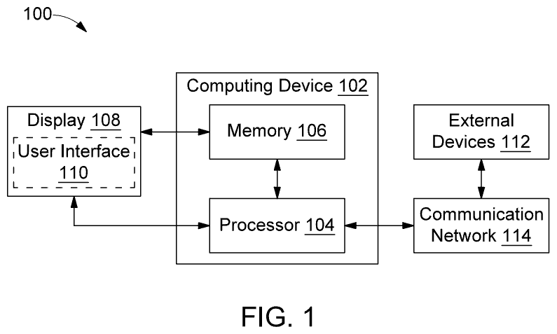

Referring now to FIG. 1, a block diagram of an exemplary system 100 for generating customized documentation of legacy source codes is illustrated, in accordance with some embodiments of the present disclosure. The system 100 may implement a computing device 102 (for example, a server, a desktop, a laptop, a notebook, a netbook, a tablet, a smartphone, a mobile phone, or any other computing device), in accordance with some embodiments of the present disclosure. The computing device 102 may generate customized documentation of legacy source codes through a semantic network, generated via a Large Language Model (LLM), based on the legacy source codes and associated business taxonomies. The legacy source code may be a source code of an application for which the customized documentation is required. Business taxonomies may include a hierarchical arrangement of business functionalities (or software functionalities) predefined by a user (or an organization thereof). The business taxonomies are provided for additional reference and context required for generating customized documentation.

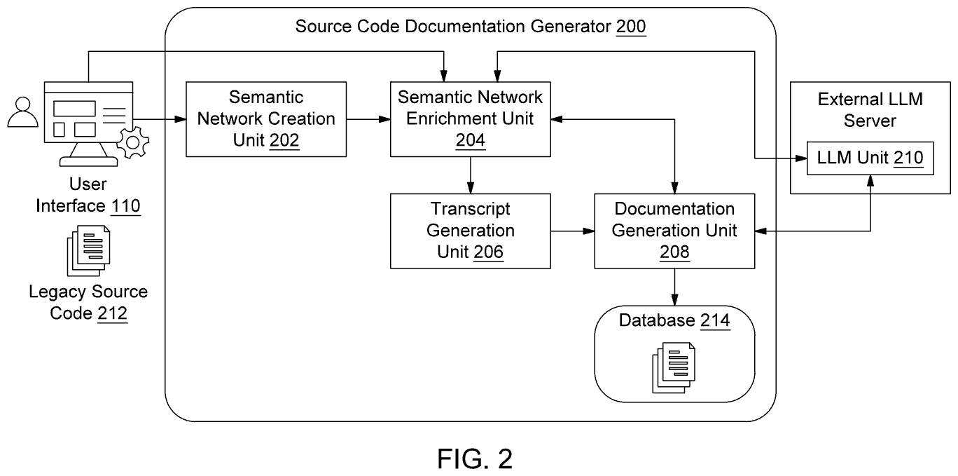

As will be described in greater detail in conjunction with FIG. 2-17, the computing device 102 may create a semantic network based on a legacy source code through pattern identification of the legacy source code using a deterministic crawler. Upon creating the semantic network, the computing device 102 may generate, via an LLM, an enriched semantic network from the semantic network based on an input reference taxonomy in response to a network enrichment prompt. The enriched semantic network may include a mapping between the semantic network and the input reference taxonomy. The network enrichment prompt may include the semantic network, the legacy source code extracted from one of the properties of the corresponding nodes, the input reference taxonomy, and a set of network enrichment instructions. The input reference taxonomy may include a hierarchical arrangement of a plurality of source code functionalities. The computing device 102 may further include generating one or more transcripts for the enriched semantic network using a deterministic technique. Each of the one or more transcripts may be a natural language description of the enriched semantic network based on a predefined context. The computing device 102 may further include generating, via the LLM, a documentation file of the legacy source code for each of a set of personas based on the one or more transcripts in response to a persona-specific documentation prompt. The persona-specific documentation prompt may include the one or more transcripts, a predefined persona-specific prompt template, and a set of documentation instructions.

Further, the computing device 102 may include a processor 104 and a memory 106. In one embodiment, the computing resource may be the processor 104. The memory 106 may store instructions that, when executed by the processor 104, cause the processor 104 to dynamically manage computing resource locking, in accordance with aspects of the present disclosure. The memory 106 may also store various data (for example, the legacy source code, the deterministic crawler, the enriched semantic network, the input reference taxonomy, the set of network enrichment instructions, the plurality of source code functionalities, the unique set of transcript generation instructions, and the like) that may be captured, processed, and/or required by the system 100.

The computing device 102 may further include a display 108. A user may interact with the computing device 102 via a user interface 110 accessible via the display 108. The system 100 may also include one or more external devices 112 and the computing device 102 may interact with the one or more external devices 112 over a communication network 114 for sending or receiving various data. The communication network 114, for example, may include, but may not be limited to, a Wireless Fidelity (Wi-Fi) network, a Light Fidelity (Li-Fi) network, a Local Area Network (LAN), a Wide Area Network (WAN), a Metropolitan Area Network (MAN), a satellite network, the internet, a fiber optic network, a coaxial cable network, an infrared (IR) network, a Radio Frequency (RF) network, or a combination thereof. The one or more external devices 112 may include, but may not be limited to a remote server, a laptop, a netbook, a notebook, a smartphone, a mobile phone, a tablet, or any other computing device.

Referring now to FIG. 2, a functional block diagram of an exemplary source code documentation generator 200 for generating customized documentation of legacy source codes is illustrated, in accordance with some embodiments of the present disclosure. FIG. 2 is explained in conjunction with FIG. 1. The source code documentation generator 200 may be analogous to the computing device 102. The source code documentation generator 200 may include, within the memory 106, a semantic network creation unit 202, a semantic network enrichment unit 204, a transcript generation unit 206, a documentation generation unit 208 and an LLM unit 210. The memory 106 may also include a legacy source code 212 and a database 214. The LLM unit 210 may include an LLM. The LLM unit 210 may be hosted on an external server or may be internally hosted within the source code documentation generator 200.

In one embodiment, the user interface 110 receives the legacy source code 212 and an input reference taxonomy (i.e., a business taxonomy) from a user. The legacy source code 212 may include one or more code files, each including a plurality of lines of code. The input reference taxonomy may include a hierarchical arrangement of a plurality of source code functionalities (or business functionalities). In an embodiment, the user may upload the legacy source code 212 to the user interface 110 from a folder. Alternatively, the user may provide a link (i.e., a path) to the legacy source code 212 stored in an external database. The legacy source code 212 may then be retrieved from the link. Further, the user interface 110 may send the legacy source code 212 to the semantic network creation unit 202. Additionally, the user interface 110 may send the input reference taxonomy to the semantic network enrichment unit 204.

The semantic network creation unit 202 may create a semantic network based on the legacy source code 212 through pattern identification of the legacy source code 212 using a deterministic crawler. To create the semantic network, the semantic network creation unit 202 may identify a set of nodes and a set of properties associated with each of the set of nodes, through pattern identification of the legacy source code using the deterministic crawler. Each of the set of nodes corresponds to a code snippet in the legacy source code. The set of properties may include, but may not be limited to, a node ID, a function name, and a program name of each of the set of nodes. It should be noted that the code snippet is also one of the set of properties.

Further, the semantic network creation unit 202 may determine a set of edges connecting the set of nodes through pattern identification of the set of nodes using the deterministic crawler. Each of the set of edges is indicative of a relationship between two of the set of nodes. Further, the semantic network creation unit 202 may create the semantic network from the set of nodes, the set of properties for each of the set of nodes, and the set of edges. In other words, the crawler is preconfigured to identify specific patterns in the legacy source code 212 and may use these patterns to create appropriate nodes and edges (i.e., connections between nodes) in the semantic network. It may be noted that the deterministic crawlers may be preconfigured and embedded in the semantic network creation unit 202 as a collection of sub-components. Each deterministic crawler may be specialized in a particular coding or scripting language, such as COBOL, PL/1, Adabas Natural, DB2 stored procedures, Java, Visual Basic, and the like.

Further, the semantic network creation unit 202 may send the semantic network to the semantic network enrichment unit 204. Additionally, the semantic network enrichment unit 204 may receive the input reference taxonomy from the user via the user interface 110. In another embodiment, the input reference taxonomy may be pre-stored in an external database. The semantic network enrichment unit 204 may then retrieve the input reference taxonomy from the external database through a link (i.e., a path) provided by the user via the user interface 110. The input reference taxonomy may include a set of keywords for each of the source code functionalities. The hierarchical arrangement may include a set of specificity levels. The number of specificity levels may vary. By way of an example, the set of specificity levels may include domain, sub-domain, and capabilities.

Further, the semantic network enrichment unit 204 may generate, via the LLM, an enriched semantic network from the semantic network based on the input reference taxonomy in response to a network enrichment prompt. The enriched semantic network may include a mapping between the semantic network and the input reference taxonomy. The network enrichment prompt may include the semantic network (which embeds the legacy source code), the input reference taxonomy, and a set of network enrichment instructions. To generate the enriched semantic network, for each of one or more of the set of nodes, the semantic network enrichment unit 204 may retrieve the code snippet (a property of the node) and remaining of the set of properties from the semantic network. The semantic network enrichment unit 204 may preprocess the code snippet corresponding to each of the one or more of the set of nodes.

The semantic network enrichment unit 204 may then create the network enrichment prompt using the semantic network (including the node IDs, the function name, the program name, etc., in the set of properties), the code snippet for each of the set of nodes (as another node property), the input reference taxonomy, and the set of network enrichment instructions. The semantic network enrichment unit 204 may then send the network enrichment prompt to the LLM unit 210. In other words, the LLM unit 210 may receive the code snippet along with the function name and the program name along with the input reference taxonomy via the network enrichment prompt.

Further, the LLM unit 210 may input the network enrichment prompt to the LLM. For each of the set of nodes, the LLM unit 210 may compare, via the LLM, the code snippet with the set of keywords for each of a plurality of high specificity level functionalities from the plurality of source code functionalities upon receiving the network enrichment prompt. It should be noted that the plurality of high specificity level functionalities may be the lowest level functionalities in the hierarchical arrangement of the input reference taxonomy. For example, the plurality of high specificity level functionalities may correspond to the capabilities. Further, the LLM unit 210 may identify, via the LLM, one or more relevant source code functionalities from the plurality of high specificity level functionalities for each of the set of nodes based on the comparing. Further, the LLM unit 210 may map, via the LLM, each of the one or more relevant source code functionalities to at least one of the set of nodes of the semantic network.

The semantic network enrichment unit 204 may receive the input reference taxonomy relevant to the legacy source code 212 from the LLM unit 210. Upon receiving the relevant reference taxonomy, the semantic network enrichment unit 204 may generate the enriched semantic network. Further, the semantic network enrichment unit 204 may send the enriched semantic network to the transcript generation unit 206. The transcript generation unit 206 may then generate one or more transcripts for the enriched semantic network using a deterministic technique. It should be noted that each of the one or more transcripts is a natural language description of the enriched semantic network based on a predefined context.

The transcript generation unit 206 may send the one or more transcripts and the plurality of high specificity level functionalities to the documentation generation unit 208. Further, the documentation generation unit 208 may generate, via the LLM, a documentation file of the legacy source code 212 for each of a set of personas based on the one or more transcripts in response to a persona-specific documentation prompt. The persona-specific documentation prompt may include the one or more transcripts, a predefined persona-specific prompt template, and a set of documentation instructions. To generate the documentation file, the documentation generation unit 208 may generate, for each persona of the set of personas, the persona-specific documentation prompt using the one or more transcripts, the predefined persona-specific prompt template for the persona, and the set of documentation instructions. The set of documentation instructions may include the plurality of high specificity level functionalities. The documentation generation unit 208 may then input the persona-specific documentation prompt to the LLM unit 210.

The LLM unit 210 may then identify, via the LLM, one or more of the set of nodes for an additional context requirement for documentation file generation. In other words, the documentation generation unit 208 may receive a list of node IDs from the LLM unit 210, for which additional details may be required. Further, the documentation generation unit 208 may retrieve a code snippet of the legacy source code 212 corresponding to each of the one or more of the set of nodes from the enriched semantic network through a semantic query (i.e., a database query). In other words, the semantic query may be used to retrieve the additional details corresponding to each node ID of the list of node IDs from the enriched semantic network.

Further, the documentation generation unit 208 may send the code snippet to the LLM unit 210 corresponding to the list of node IDs. The LLM unit 210 may generate, via the LLM, the documentation file of the legacy source code 212 for the persona in accordance with the predefined persona-specific prompt template and a set of documentation instructions, based on the one or more transcripts and the code snippet corresponding to each of the one or more of the set of nodes. In other words, the documentation generation unit 208 may receive the persona-specific knowledge nuggets for all the personas from the LLM unit 210. The documentation generation unit 208 may send persona-specific knowledge nuggets for all the personas to the database 214.

It should be noted that all such aforementioned units 202-210 may be represented as a single module or a combination of different modules. Further, as will be appreciated by those skilled in the art, each of the units 202-210 may reside, in whole or in parts, on one device or multiple devices in communication with each other. In some embodiments, each of the units 202-210 may be implemented as dedicated hardware circuit comprising custom application-specific integrated circuit (ASIC) or gate arrays, off-the-shelf semiconductors such as logic chips, transistors, or other discrete components. Each of the units 202-210 may also be implemented in a programmable hardware device such as a field programmable gate array (FPGA), programmable array logic, programmable logic device, and so forth. Alternatively, each of the units 202-210 may be implemented in software for execution by various types of processors (e.g., the processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module, and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for dynamically managing computing resource locking. For example, the exemplary system 100 and the associated computing device 102, may dynamically manage computing resource locking by the processes discussed herein. In particular, as will be appreciated by those of ordinary skill in the art, control logic and/or automated routines for performing the techniques and steps described herein may be implemented by the system 100 and the associated computing device 102, either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

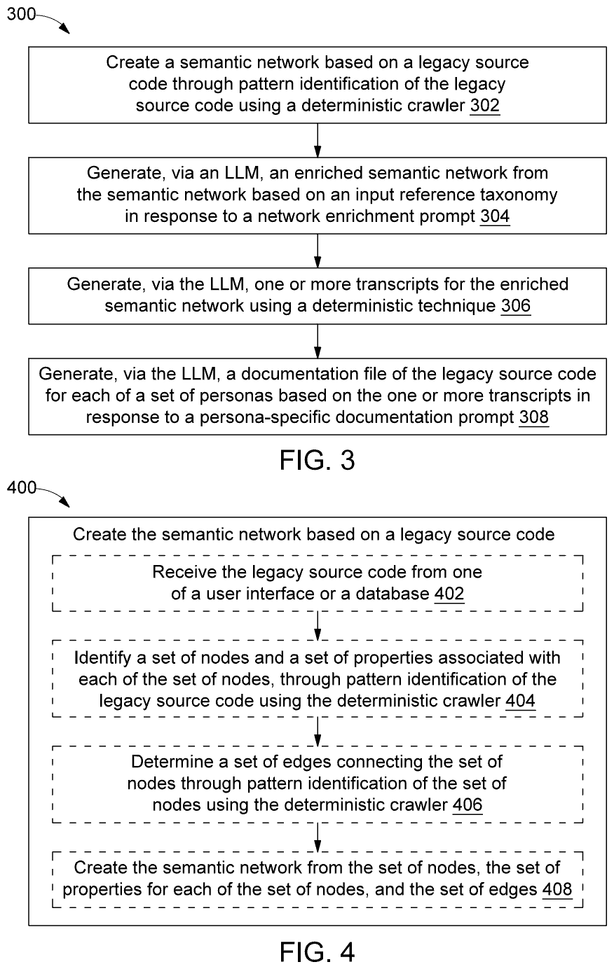

Referring now to FIG. 3, an exemplary method 300 for generating customized documentation of legacy source codes is depicted via a flowchart, in accordance with some embodiments of the present disclosure. The method 300 may be implemented by the computing device 102 of the system 100. The method 300 may include creating, by the semantic network creation unit 202, a semantic network based on a legacy source code through pattern identification of the legacy source code using a deterministic crawler, at step 302. This is explained in greater detail in conjunction with FIG. 4.

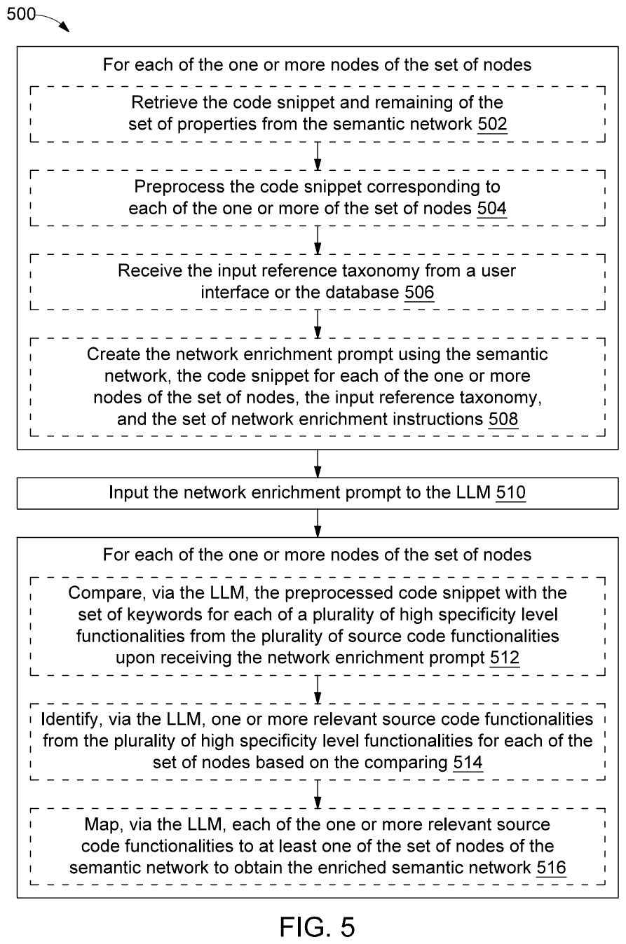

Upon creating the semantic network, the method 300 may include generating, by the semantic network enrichment unit 204 via the LLM unit 210, an enriched semantic network from the semantic network based on an input reference taxonomy in response to a network enrichment prompt, at step 304. The enriched semantic network may include a mapping between the semantic network and the input reference taxonomy. The network enrichment prompt may include the semantic network, the input reference taxonomy, and a set of network enrichment instructions. The input reference taxonomy may include a hierarchical arrangement of a plurality of source code functionalities. This is explained in greater detail in conjunction with FIG. 5.

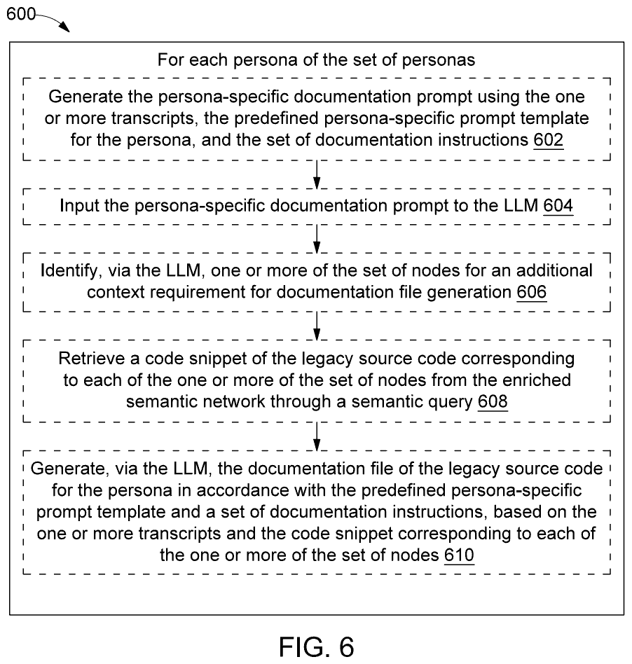

Further, the method 300 may include generating, by the transcript generation unit 206 via the LLM unit 210, one or more transcripts for the enriched semantic network using a deterministic technique, at step 306. Each of the one or more transcripts may be a natural language description of the enriched semantic network based on a predefined context. This is explained in greater detail in conjunction with FIG. 6.

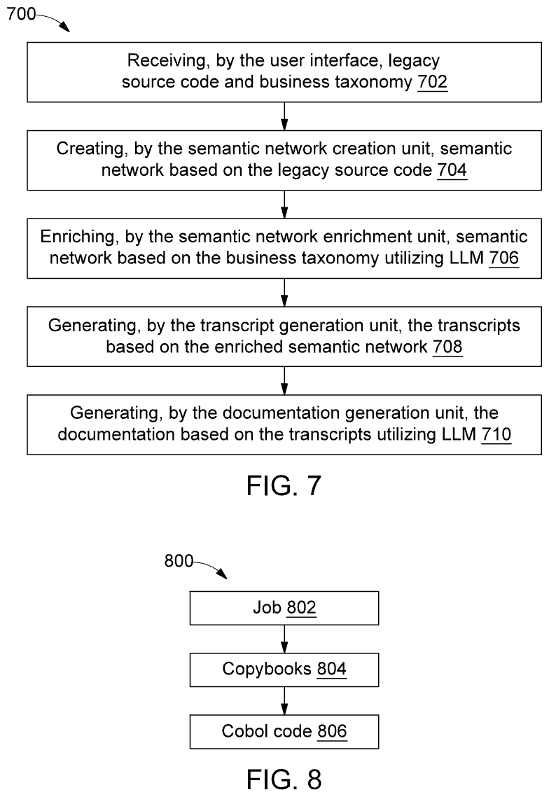

Further, the method 300 may include generating, by the documentation generation unit 208 via the LLM unit 210, a documentation file of the legacy source code for each of a set of personas based on the one or more transcripts in response to a persona-specific documentation prompt, at step 308. The persona-specific documentation prompt may include the one or more transcripts, a predefined persona-specific prompt template, and a set of documentation instructions. This is explained in greater detail in conjunction with FIG. 7.

Referring now to FIG. 4, an exemplary method 400 for creating the semantic network based on a legacy source code is depicted via a flowchart, in accordance with some embodiments of the present disclosure. The method 400 may include creating, by the semantic network creation unit 202, the semantic network based on the legacy source code, at step 302. The step 302 may include step 402, step 404, step 406, and step 408. Further, the method 400 may include receiving, by the semantic network creation unit 202, the legacy source code from one of a user interface or a database, at step 402. Further, the method 400 may include identifying, by the semantic network creation unit 202, a set of nodes and a set of properties associated with each of the set of nodes, through pattern identification of the legacy source code using the deterministic crawler, at step 404. Each of the set of nodes corresponds to a code snippet in the legacy source code. It should be noted that the code snippet is one of the set of properties. Further, the method 400 may include determining, by the semantic network creation unit 202, a set of edges connecting the set of nodes through pattern identification of the set of nodes using the deterministic crawler, at step 406. Further, the method 400 may include creating, by the semantic network creation unit 202, the semantic network from the set of nodes, the set of properties for each of the set of nodes, and the set of edges, at step 408.

Referring now to FIG. 5, an exemplary method 500 for generating the enriched semantic network is depicted via a flowchart, in accordance with some embodiments of the present disclosure. Once the semantic network is created, the semantic network enrichment unit 204 may query one or more of the set of nodes of the semantic network (particularly nodes that pertain atomic units of logic) using knowledge graph database queries against the semantic network. For each of the one or more nodes of the set of nodes, the method 500 may include retrieving, by the semantic network enrichment unit 204, the code snippet and remaining of the set of properties from the semantic network using the knowledge graph database queries, at step 502. It should be noted that the code snippet is one of the set of properties. Further, the method 500 may include preprocessing, by the semantic network enrichment unit 204, the code snippet corresponding to each of the one or more of the set of nodes, at step 504. Further, the method 500 may include receiving, by the semantic network enrichment unit 204, the input reference taxonomy from a user interface (such as the user interface 110) or the database, at step 506. Further, the method 500 may include creating, by the semantic network enrichment unit 204, the network enrichment prompt using the semantic network, the code snippet for each of the one or more nodes of the set of nodes, the input reference taxonomy, and the set of network enrichment instructions, at step 508.

Further, the method 500 include inputting, by the by the semantic network enrichment unit 204 and the LLM unit 210, the network enrichment prompt to the LLM, at step 510. Further, for each of the one or more nodes of the set of nodes, the method 500 may include comparing, by the LLM unit 210 via the LLM, the preprocessed code snippet with the set of keywords for each of a plurality of high specificity level functionalities from the plurality of source code functionalities upon receiving the network enrichment prompt, at step 512. Further, the method may include identifying, by the LLM unit 210 via the LLM, one or more relevant source code functionalities from the plurality of high specificity level functionalities for each of the set of nodes based on the comparing, at step 514. Further, the method may include mapping, by the LLM unit 210 via the LLM, each of the one or more relevant source code functionalities to at least one of the set of nodes of the semantic network to obtain the enriched semantic network, at step 516. Through the enriched semantic network, the transcript generation unit 206 may generate the one or more transcripts using the deterministic technique.

Referring now to FIG. 6, an exemplary method 600 for generating the documentation file is depicted via a flowchart, in accordance with some embodiments of the present disclosure. The documentation generation unit 208 may receive the one or more transcripts from the transcript generation unit 206. Further, for each persona from the set of personas, the method 600 may include generating, by the documentation generation unit 208, the persona-specific documentation prompt using the one or more transcripts, the predefined persona-specific prompt template for the persona, and the set of documentation instructions, at step 602. Further, the method 600 may include inputting, by the documentation generation unit 208 and the LLM unit 210, the persona-specific documentation prompt to the LLM, at step 604. Further, the method 600 may include identifying, by the LLM unit 210 via the LLM, one or more of the set of nodes for an additional context requirement for documentation file generation, at step 606. The LLM unit 210 may provide the node IDs of the one or more of the set of nodes to the documentation generation unit 208.

Further, the method 600 may include retrieving, by the documentation generation unit 208, a code snippet of the legacy source code corresponding to each of the one or more of the set of nodes from the enriched semantic network through a semantic query, at step 608. Further, the method 600 may include generating, by the LLM unit 210 via the LLM, the documentation file of the legacy source code for the persona in accordance with the predefined persona-specific prompt template and a set of documentation instructions, based on the one or more transcripts and the code snippet corresponding to each of the one or more of the set of nodes, at step 610.

Referring now to FIG. 7, a detailed exemplary method 700 for generating persona-specific source code documentation is depicted via a flowchart, in accordance with some embodiments of the present disclosure. The method 700 may include receiving, by the user interface 110, the legacy source code 212 and the input reference taxonomy (now onwards referred as business taxonomy), at step 702. The user interface 110 may receive the legacy source code (files) 212 from the user as an input. The user may directly upload the legacy source code files, or may provide a link or a file path to the legacy source code 212 via the user interface 110. The legacy source code 212 may include modules or files in a legacy programming language. For example, the legacy source code 212 may include COBOL modules, PL/I modules, Adabas Natural modules, VBA modules, or any other programing language modules.

Referring now to FIG. 8, an exemplary set of items 800 for COBOL is illustrated, in accordance with some embodiments of the present disclosure. By way of an example, the Cobol module (the Cobol Folder) may include files such as a Job Control Language (JCL)/Proc, data Persistence structures (such as Data Table definition files, VSAM definition files, database stored procedures or Triggers, CICS Maps (terminal screen definitions), or any other constructs that can be mapped onto a sematic network (for example, but not limited to, sorting algorithms, utilities, schedulers, external inbound/outbound feeds, and reports). The set of items 800 may include a JOB 802, a COPYBOOK 804, and a COBOL code 806. By way of an example, the JOB 802 may be a JCL file that includes instructions for execution of a COBOL program. The COPYBOOK 804 may include definitions of the data structures of the COBOL program. The COBOL code 806 may include the code of the COBOL program to be executed.

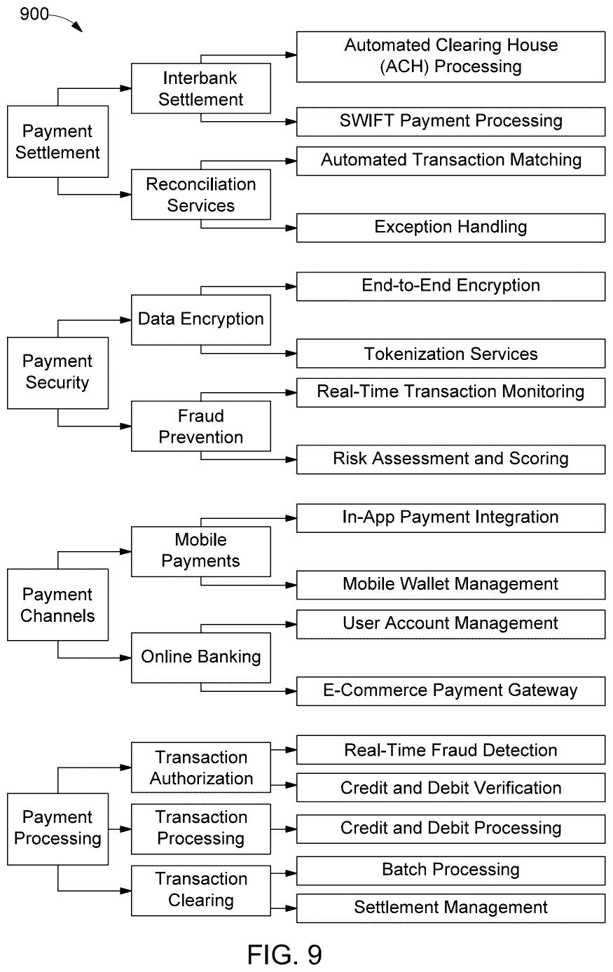

Referring now to FIG. 9, a schematic diagram of an exemplary business taxonomy 900 (i.e., input reference taxonomy) is illustrated, in accordance with some embodiments of the present disclosure. The user interface 110 may receive the business taxonomy 900 in text format (such as JSON) from the user as input. By way of an example, the business taxonomy 900 provided by the user is structured into three tiers (i.e., three specificity levels) namely, domain, sub-domain, and capability (i.e., business capability). Each domain encompasses one or more sub-domains. Further, each sub-domain includes one or more capabilities. Thus, the three specificity levels of the business taxonomy 900 may form a hierarchical one-to-many relationship. The level of specificity increases from domain to capability. Therefore, capability is the highest specificity level in the business taxonomy 900.

For example, the domain may be “payment processing”. The sub-domains associated with the “payment processing” domain may be “transaction authorization”, “transaction processing”, and “transaction clearing”. The capabilities associated with the “transaction authorization” sub-domain may be “Real-Time Fraud Detection” and “credit and debit verification”. The capability associated with the “transaction processing” sub-domain may be “credit and debit processing”. The capabilities associated with the “transaction clearing” sub-domain may be “batch processing” and “settlement management”.

Additionally, the business taxonomy 900 may include a set of keywords associated with each domain, each sub-domain, and each capability. The set of keywords may assist in aligning the legacy source code 212 with the most relevant business taxonomy labels.

An example of the set of keywords associated with each domain, each sub-domain, and each capability of the business taxonomy 900 may be as follows.
{
   “domains”:[
      {
         “name”:“Payment Processing”,
         “keywords”: [
         “process”, “payment”, “transact”, “transaction”, “authorize”, “authorization”, “clear”, “clearing”, “settle”, “settlement”, “batch”, “batching”, “gateway”, “gateway”, “middleware”, “processor”, “paymentprocessor”, “remittance”, “fundtransfer”, “transfer”, “exchange”, “liquidity”, “reconciliation”, “reconcile”, “fee”, “tariff”, “charge”, “commission”, “currency”, “foreignexchange”, “fx”
      ],
      “sub-domains”: [
         {“name”:“Transaction Authorization”,
         “keywords”: [
         “authorize”, “authorization”, “approve”, “approvepayment”, “validate”, “validation”, “verify”, “verification”, “authentication”, “auth”, “creditcheck”, “credit”, “debitcheck”, “debit”, “fraudcheck”, “fraud”, “riskassessment”, “risk”, “security”, “secure”, “tokenization”, “tokenize”, “compliance”, “regulation”, “rulesengine”, “rules”, “decisionmaking”, “decision”, “approval”, “deny”, “reject”
         [,
         “capabilities”: [
         {
         “name”: “Real-Time Fraud Detection”,
         “keywords”: [
         “fraud”, “detect”, “detection”, “real-time”, “monitor”, “monitoring”, “analytics”, “analytic”, “machinelearning”, “machinelearning”, “modeling”, “model”, “pattern”, “patterns”, “anomaly”, “anomalies”, “behavior”, “behavioral”, “risk”, “assessment”, “score”, “scoring”, “alerts”, “alerting”, “notification”, “notify”, “response”, “reaction”, “prevention”, “secure”, “security”, “protection”
         ]
         },
         {
         “name”:“Credit and Debit Verification”,
         “keywords”: [
         “credit”, “debit”, “verify”, “verification”, “validate”, “validation”, “check”, “checking”, “account”, “accounting”, “balance”, “balances”, “funds”, “funding”, “insufficient”, “sufficient”, “available”, “availability”, “overdraft”, “limit”, “limits”, “holder”, “holders”, “identity”, “identification”, “authentication”, “auth”, “secure”, “security”, “compliance”, “regulation”, “rules”
         ]
         }
         ]
         },
         {
         “name”: “Transaction Clearing”,
         “keywords”: [
         “clear”, “clearing”, “settle”, “settlement”, “batch”, “batching”, “gateway”, “gateway”, “middleware”, “processor”, “paymentprocessor”, “remittance”, “fundtransfer”, “transfer”, “exchange”, “liquidity”, “reconciliation”, “reconcile”, “fee”, “tariff”, “charge”, “commission”, “currency”, “foreignexchange”, “fx”, “netting”, “grosssettlement”, “settlesystem”, “interbank”, “bic”, “swift”, “ach”, “automatedclearinghouse”
         ],
         “capabilities”: [
         {
         “name”: “Batch Processing”,
         “keywords”: [
         37 batch”, “batching”, “process”, “processing”, “bulk”, “bulkprocessing”, “schedule”, “scheduling”, “automation”, “automate”, “automated”, “job”, “jobs”, “queue”, “queuing”, “throughput”, “throughput”, “performance”, “perform”, “optimize”, “optimization”, “scaling”, “scale”, “resource”, “management”, “manage”, “monitor”, “monitoring”, “control”, “controller”, “orchestration”, “coordination”
         ]
         },
         {
         “name”: “Settlement Management”,
         “keywords”: [
         “settlement”, “settle”, “manage”, “management”, “reconcile”, “reconciliation”, “accounting”, “account”, “balance”, “balances”, “funds”, “funding”, “liquidity”, “liquiditymanagement”, “transfer”, “transfers”, “settlesystem”, “system”, “interbank”, “bic”, “swift”, “ach”, “automatedclearinghouse”, “netting”, “grosssettlement”, “transaction”, “transactions”, “secure”, “security”, “compliance”, “regulation”, “rules”, “audit”, “auditing”
         ]
         }
         ]
         }
         ]
      },
      {
         “name”: “Payment Channels”,
         “keywords”: [
         “channel”, “channels”, “platform”, “platforms”, “interface”, “interfaces”, “mobile”, “mobilepayment”, “online”, “internet”, “web”, “webpayment”, “app”, “application”, “applicationpayment”, “pointofsale”, “pos”, “terminal”, “atm”, “branch”, “agent”, “remote”, “remotechannel”, “contactless”, “nfc”, “chip”, “swipe”, “card”, “cards”, “digital”, “digitalpayment”, “ecommerce”, “ecommercepayment”
         ],
         . . .
         {
         “name”: “Exception Handling”,
         “keywords”: [
         “exception”, “exceptions”, “handling”, “handle”, “manage”, “management”, “error”, “errors”, “discrepancy”, “discrepancies”, “alert”, “alerts”, “notification”, “notify”, “resolve”, “resolution”, “investigate”, “investigation”, “workflow”, “flows”, “process”, “processing”, “automation”, “automate”, “secure”, “security”, “audit”, “auditing”, “compliance”, “regulation”, “rules”, “escalation”, “escalate”
         ]
         }
         ]
         }
         ]
      }
   ]
}

The user interface 110 may send the legacy source code 212 to the semantic network creation unit 202. Additionally, the user interface 110 may send the business taxonomy 900 to the semantic network enrichment unit 204.

Referring back to FIG. 7, the method 700 may include creating, by the semantic network creation unit 202, a semantic network based on the legacy source code 212, at step 704. The semantic network creation unit 202 may receive the legacy source code 212 from the user interface 110. The semantic network creation unit 202 may use the deterministic crawlers (known in the art) with predefined customizations to crawl the legacy source code 212 to create the semantic network (knowledge graph). The semantic network is created deterministically via the deterministic crawler. That is to say, the deterministic crawler may identify specific patterns in the provided legacy source code 212 and may use the identified patterns to create appropriate nodes and edges (i.e., connections between nodes) in the semantic network. It should be noted that the creation of semantic network is agnostic of the type (programming language, format, etc.) of the legacy source code 212 being analyzed. The deterministic dedicated code crawlers may be embedded as a collection of sub-components (that use common and standard ways of plugging into the system 100) in the semantic network creation unit 202. Each crawler may be specialized in a particular coding or scripting language-such as for COBOL, PL/I, Adabas Natural, DB2 Stored Procedures, Java, Visual Basic, and the like.

To create the semantic network, the semantic network creation unit 202 may pre-scan each file of the legacy source code 212 to determine which crawler to use for which source code files. Additionally, during pre-scanning, some pre-processing steps may be performed. For example, white spaces may be removed, file extensions may be appropriately renamed, etc. Upon pre-scanning, the semantic network creation unit 202 may use the determined language/script-specific crawler to crawl the code, searching for specific patterns in the text in the file that is being analyzed. In this way, heterogenous technology stacks may be reverse engineered.

By way of an example, a crawler process for identifying nodes and edges may include one source code file per Parser Instance and the list of directories to reach any required library files which returns a compilation unit (parser-specific structure). The divisions of the compilation unit (logical sections of the program) may be sent to a specific service layer for processing. During the Code Logic Service process, the crawler process may iterate over every line in the source code statement and if it matches, for example, a call statement (parser-specific structure), the crawler process may further parse the content of the parameter (e.g., CALL PROGRAMNAME) to match only the Program Name and persists a “Call” node. The crawler process may further keep processing all the other components and saves the Program with all the nodes associated with it. The crawler process may repeat until every source code file has persisted. The crawler process then may iterate over all the nodes that infer connections with other components of the source code (such as “Call” nodes) across the entire graph wires them together. When a pattern is recognized, the crawler process may create either a corresponding node or a corresponding edge in the semantic network.

The semantic network may be stored in the graph database (such as the database 214). For each node, the database 214 may assign a unique id which is added as a property to the set of properties of the node. The database 214 may also store the reference to the original legacy source code 212 as a property named filePath. The original legacy source code 212 may be stored as a property named rawCode. Similarly, a program_name (the name of the source code file/construct that may contain the code function) and a function_name (the name of the code paragraph, function, or method, depending on the nomenclature may be used by the programming language that specifies a reusable, atomic, block of code logic) may also be stored with each node as properties of the nodes.

By way of an example, libraries used for crawling the code files may include COBOL-specific library (for example, com.github.uwol.proleap-cobol-parser: 2.4.0), and libraries specific for other programming languages, such as DB2, BMS (screen mapping), JCL, Natural Adabas (for example, ANTLR4+Lexers and grammars) or the like.

By way of an example, for COBOL source code, the following Regex pattern may be used.
DEFAULT_XML_PARSE_REGEX_PATTERN=“(?s)[\r\n]*XML\\s+PARSE.*?END-XML”;

The Regex pattern finds the XML PARSE structure (which is not understandable by the COBOL PROLEAP library) to remove the structure as a comment during the parsing and to inject the remaining code on the rawCode node property after parsing. The preprocessing tasks may be done using approaches such as REGEX or the like. The semantic network may systematically built up until all the source code has been processed. Each node may contain the corresponding legacy source code 212 as the rawCode property. By way of an example, some of the set of properties of a node include program_name (i.e., the name of the source code file/construct that contains the code function), function_name (i.e., the name of the code paragraph, function, or method), id (i.e., unique ID for each node), filePath (i.e., reference to the original source code file), rawCode (i.e., original source code-typically expressed as, for example, code paragraphs in Cobol programs or functions in VBA), and the like. The semantic network creation unit 202 may send the semantic network (in JSON format) to the semantic network enrichment unit 204.

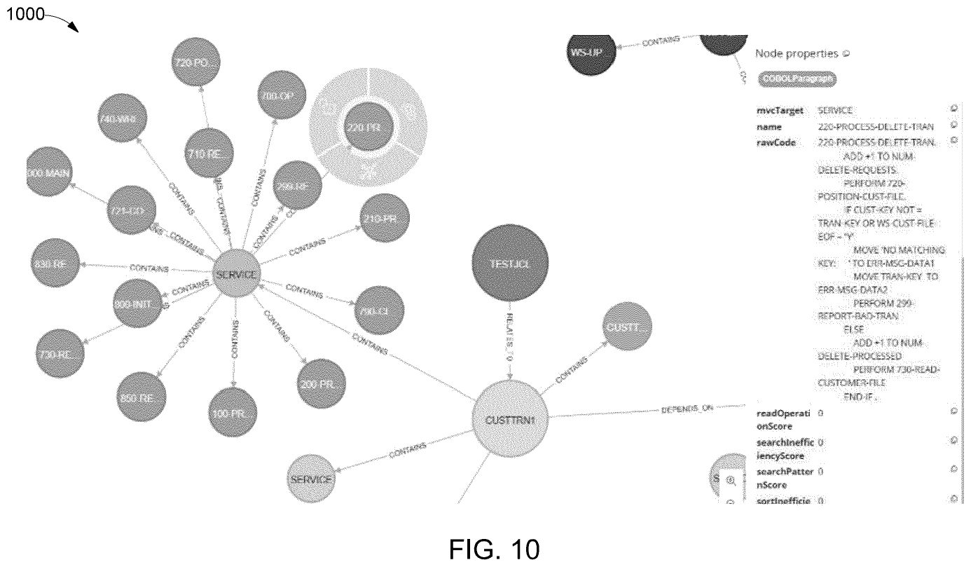

Referring now to FIG. 10, an exemplary Semantic Network 1000 is illustrated, in accordance with some embodiments of the present disclosure. The semantic network 1000, when visualized, may include the set of nodes represented using circles and the set of edges or connections that are represented with the directional lines between the set of nodes. In an embodiment, the user may interact with the visualized semantic network 1000. For example, when the user may click on a node, a set of properties associated with the node may be rendered on the user interface 110. The name of the node and the set of properties associated with the node may be stored in the corresponding text file (e.g., JSON file) of the semantic network 1000. By way of an example, the set of properties for ‘COBOLParagraph’ node may include ‘mvcTarget’, ‘name’, ‘rawCode’, ‘readOperationScore’, ‘searchinefficiencyScore’, ‘searchPatternScore’, or the like.

Referring back to FIG. 7, the method 700 may further include enriching, by the semantic network enrichment unit 204, the semantic network (for example, the semantic network 1000) based on the business taxonomy utilizing the LLM, at step 706. The semantic network enrichment unit 204 may receive the business taxonomy (such as the business taxonomy 900) from the user interface 110. The semantic network enrichment unit 204 may receive the semantic network 1000 from the semantic network creation unit 202. The semantic network enrichment unit 204 may query specific nodes of the semantic network 1000, particularly the atomic nodes of logic using database 214 queries against the semantic network 1000. The atomic nodes may be the nodes that include the rawCode property expressed as code paragraphs in COBOL programs or functions in VBA. The queries may remove standard programming keywords such as “IF”, “ELSE”, “EVALUATE” and the like to reduce the payload that may be later on sent to the LLM unit 210. The query may return the legacy source code snippet (i.e., rawCode property of the corresponding node of the semantic network 1000) together with the function_name and the program_name that corresponds to the source code inside rawCode.

The semantic network enrichment unit 204 may send the graph database query results along with the reference business taxonomy (domain, sub-domain and capability—with/without keywords) to the LLM unit 210 with a network enrichment prompt. The network enrichment prompt may instruct the LLM to identify relevant business taxonomy label (i.e., relevant domain, sub-domain and capability) corresponding to the legacy source code snippet (rawCode). The set of keywords in the business taxonomy corresponding to the domain, sub-domain, and capability may assist the LLM unit 210 in associating the relevant domain, sub-domain, and capability with the legacy source code snippet (rawCode).

By way of an example, the network enrichment prompt may be defined as follows.

### Business Taxonomy Extraction per Program:

“Look at the following extract of a graph database query result at the end of this prompt.
It contains a list of nodes with metadata. your task is to align each code function (equivalent to code paragraph for COBOL, method for JAVA, or subroutine for VBA, etc.), represented by “function_name”, as closely as possible to the following reference business taxonomy. {user provided taxonomy}

### Detailed Instructions:

Each of the other nodes must align to one and only taxonomy item. A taxonomy item, may in turn, align to many nodes.
If you find a reasonably good match, I want you to return the corresponding function_name, program_name, the domain, the sub-domain, as well as the capability in tabular format.
You must return the data using the following sample JSON pattern {“domain”: “Order Management”, “sub-domain”: “Order Identification”, “capability”: “Retrieve Current Identifier”, “function_name”: “100-VALIDATE”, “program_name”: “CUSTTRN2”}
Return only the JSON outlined in the previous instruction. Be sure to return all the properties, as aligned with the reference taxonomy, i.e.: “domain”, “sub-domain”, “capability”, “function_name”, “program_name”.
Do not provide any additional clarifications or text of any nature.
   Here is the result set that I want you to analyze:
{extract of graph database query}”

It should be noted that the {user provided taxonomy} may contain the business taxonomy and {extract of graph database query} may contain the legacy source code snippet (rawCode property of the corresponding node of the semantic network 1000) together with function_name and program_name that may correspond to the source code inside rawCode.

The associations among the code units (semantic network node with associated rawCode property) and reference taxonomy items (i.e., JSON) may return to the semantic network enrichment unit 204. By way of an example, a snippet of the business taxonomy JSON may be as follows.
{
   “domain”: “Payment Processing”,
   “sub-domain”: “Transaction Authorization”,
   “capability”: “Credit and Debit Verification”,
   “function_name”: “100-VALIDATE-TRAN”,
   “program_name”: “CUSTTRN2”
}
{
   “domain”:
   “Payment Processing”,
   “sub-domain”: “Transaction Processing” “capability”:
   “Credit and Debit Verification”,
   “function_name”: “200-PROCESS-TRAN”,
   “program_name”: “CUSTTRN2”,
}

The semantic network 1000 may be updated by creating representative nodes from the JSON returned by the LLM Unit 210 for domain, sub-domain, and capability. The nodes representing domains may be associated with the respective sub-domains. The nodes representing sub-domain may be associated with the respective capabilities. The capabilities may be associated with the respective nodes in the semantic network 1000 along with the corresponding program_name and function_name properties. The steps for creating and associating nodes may be executed iteratively until all the business taxonomy labels (at capability level) may be mapped to at least a node (at program level) of the semantic network 1000. In this manner, an enriched semantic network may be created by the semantic network enrichment unit 204. The semantic network enrichment unit 204 may also prepare a list of capability names from the JSON returned by the LLM Unit 210. The semantic network enrichment unit 204 may send the enriched semantic network (in JSON format) and the list of capability names to the transcript generation unit 206.

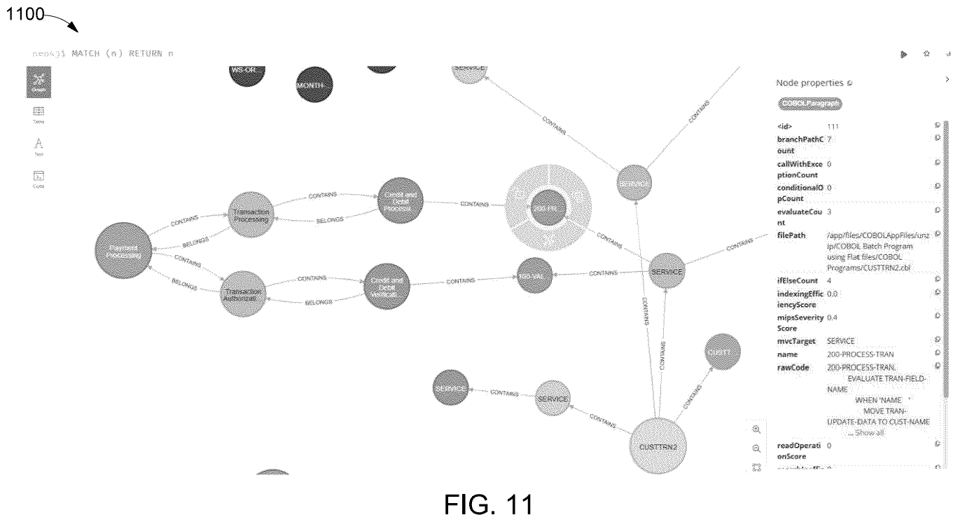

Referring now to FIG. 11, an exemplary enriched semantic network 1100 is illustrated, in accordance with some embodiments of the present disclosure. The enriched semantic network 1100 may be obtained by mapping the semantic network 1000 and the business taxonomy 900. By way of an example, the mapping may be as follows.
{
   “domain”: “Payment Processing”,
   “sub-domain”: “Transaction Authorization”,
   “capability”: “Credit and Debit Verification”,
   “function_name”: “100-VALIDATE-TRAN”,
   “program_name”: “CUSTTRN2”
},
{
   “domain”: “Payment Processing”,
   “sub-domain”: “Transaction Processing” “capability”:
   “Credit and Debit Processing”,
   “function_name”: “200-PROCESS-TRAN”,
   “program_name”: “CUSTTRN2”,
}

Thus, the node ‘100-VALIDATE-TRAN’ of the semantic network 1000 may be mapped with the capability ‘Credit and Debit Verification’. Similarly, the node ‘200-PROCESS-TRAN’ of the semantic network 1000 may be mapped with the capability ‘Credit and Debit Processing’.

Referring back to FIG. 7, the method 700 may further include generating, by the transcript generation unit 206, one or more transcripts based on the enriched semantic network (for example, the enriched semantic network 1100), at step 708. The transcript generation unit 206 may receive the enriched semantic network 1100 (in JSON format) and the list of capability names from the semantic network enrichment unit 204. Upon receiving, the transcript generation unit 206 may generate the one or more transcripts based on the enriched semantic network 1100. The one or more transcripts may be generated after scanning through the enriched semantic network 1100 (i.e. text-based JSON), sorting the enriched semantic network 1100 along different node types and then, using the properties of the node and surrounding edges, creating a text-based version of the enriched semantic network 1100. The type of node and nature of the set of edges leading from the node may be described in natural language which may assist the LLM unit 210 with accurate inference. The JSON export may include nodes corresponding to domains, sub-domains, and capabilities apart from other types of nodes.

In some embodiments, three types of transcripts may be generated including a technical transcript, a business transcript, and a callgraph. The technical transcript may focus on describing technical nodes. The business transcript may focus on business capabilities and business taxonomy, and how both may wire up to the technical nodes. The callgraph may provide a summary of how code logic flows through the various constructs (such as paragraphs in COBOL or class methods in Java) across the legacy source code 212.

The transcripts may enrich the content that is provided to the LLM unit 210 by clarifying the node types and the nature of the associations among nodes. The enriched semantic network 1100 may reduce the overall payload of information that may be passed to the LLM unit 210 considering context window constraints through removing redundant and repetitive information present in the JSON export of the virtual replica.

By way of an example, key components used for generating the technical transcript may include JSON enriched semantic network (such as the enriched semantic network 1100) for graph-based analysis, storytelling functions, and data collection functions. The transcript generation process may use JSON format of the enriched Semantic Network 1100. Nodes of the enriched Semantic Network 1100 may represent software modules (such as JCLs, COBOL programs, VB Modules, Java classes, etc.) and structures/sections or sub-components within the software modules. The structures may include code paragraphs, COBOL, class methods (Java), stored procedures, and data structures (either as variable definitions within code modules or constructs that persist data such as database tables). Edges in the enriched Semantic Network 1100 may represent relationships between the software modules, components, sub-components, etc.

Additionally, since the goal is to provide a rich semantic context to the LLM via the one or more transcripts, coding language-specific story telling functions may be used that help transform relevant parts of the JSON export of the enriched semantic network 1100 into text that contains rich semantic detail about the type of node or edge—i.e., the nature of key components of the legacy source code 212 and how the nodes and edges are inter-related. By way of an example, the storytelling functions may include, but are not limited to, tell_technology_story (the main entry point that may coordinate the entire analysis), tell_jcl_story (explains JCL components), tell_program_story (describes individual COBOL programs), tell_class_story (describes individual Object-oriented language, such as Java or C++ class), and tell_subprograms_story (describes programs or classes invoked by other programs or classes).

The data collection functions may search through the enriched semantic network 1100 to understand which tell_xxx_story functions may be called. By way of an example, the data collection functions may include, but are not limited to, get_list_of_programs (identifies COBOL programs), get_list_of_classes (identifies Java/C++ etc. classes), get_list_of_screens (extracts CICS map information), get_list_of_programs_invoked_by_jcl (identifies programs called by JCL), and get_list_of_programs_invoked_by_programs (finds programs called by other programs).

For technical transcript generation, initially the data collection functions may be used to select language-specific story telling functions of the legacy source code (identified using JSON extract of the enriched Semantic Network). The language-specific story telling functions may generate an introduction. Further, the language-specific story telling functions may add the main entry module for the technology stack (such as JCL in the case of Cobol or PL/1 etc. descriptions via tell_jcl_story). Further, the language-specific story telling functions may process code modules invoked by main or entry module. Further, the language-specific story telling functions may process standalone code modules. Further, for each code module, the language-specific story telling functions may describe how the code module may be invoked. In some embodiments, the code module may be invoked by the main module or directly through intra-module invocation. Further, for each code module, the language-specific story telling functions may identify sub-modules called by the current code module. Further, for each code module, the language-specific story telling functions may analyze sub-sections of the module (such as data definition sections and code functions). Further, for each code module, the language-specific story telling functions may detail each sub-section within these modules and sub-modules.

Special handling may be included for ensuring semantic context is provided for connecting to external constructs. Non-limiting examples for the special handling may include file handling of sub-modules, code libraries (such as copybooks that are reusable code modules in COBOL), and SQL statements/CRUD Operations/invocation of stored procedures.

The business transcript may be a text file that is derived from the enriched Semantic Network 1100. The business transcript may provide the stakeholders with a clear understanding of the business purpose and functions of the application without requiring technical knowledge.

For generating the business transcript, business classification may be extracted. To extract the business classification, the JSON format of the enriched semantic network 1100 may be used. The JSON format may include both technical code module related elements and business taxonomy classifications (i.e., domains, sub-domains, capabilities) associated with the technical code module. The enriched semantic network 1100 in JSON format is used a golden source of truth for business classification extraction.

Initially, business domains may be identified. The transcript generation unit 206 may identify the high-level business domains represented in the codebase, providing an organizational framework for understanding the application's purpose. Further, the transcript generation unit 206 may add the high-level business domains to the business transcript. Upon identifying business domains, business sub-domains may be mapped. For each business domain, the transcript generation unit 206 may identify the more specific sub-domains, creating a hierarchical business context for the application components. Upon mapping the sub-domains, business capabilities may be documented. The transcript generation unit 206 may catalogue the specific capabilities implemented within each sub-domain, connecting technical components to business functions.

Further, to generate the business transcript, introductory context may be created. The transcript generation unit 206 may generate an introduction that may outline the business domains, sub-domains and capabilities found in the application.

Further, to generate the business transcript, domain narratives may be generated. For each domain, the transcript generation unit 206 may produce a narrative description explaining its business purpose and significance within the overall application.

Further, to generate the business transcript, subdomain relationships may be detailed. The transcript generation unit 206 may create narratives explaining how sub-domains relate to their parent domains.

Further, to generate the business transcript, business capability relationships may be detailed. The transcript generation unit 206 may create narratives explaining how capabilities relate to sub-domains.

Further, to generate the business transcript, technical nodes to business functionalities may be connected. The transcript generation unit 206 may associate the specific technical constructs (such as code functions) to the capabilities the specific technical constructs may implement. The association may bridge the gap between code and business function.

The Callgraph may be a text file that may be derived from the enriched semantic network 1100.

For callgraph generation, the transcript generation unit 206 may iterate through each code module from the JSON format of the enriched semantic network 1100.

To generate the callgraph, component collection may be performed. For component collection, for each code module (for example, a COBOL program), the transcript generation unit 206 may add the code module name to the callgraph. Further, for each code module, the transcript generation unit 206 may collect code module comments and may add the code module comments to the callgraph. Further, for each code module, the transcript generation unit 206 may process code function data. Further, for each code module, the transcript generation unit 206 may add function names and comments of the functions to the callgraph.

Further, to generate the callgraph, relationship capture may be performed. For each code function, the transcript generation unit 206 may extract invocations to other code modules, cross-function calls, database table CRUD operations (SELECT, UPDATE, INSERT, FETCH, and the like), public variables, code library references, and data exchange with external components.

Further, the structure and sequence of logic calls across each code module, with the collected components and the captured relationships are scripted out to the callgraph text file.

To reduce the payload of information that may be passed to the LLM unit 210, no actual code snippets from the legacy source code 212 may be referenced in these transcript files. Rather, placeholders or pointers to where the detailed information can be discovered in the semantic network may be referenced in the technical transcript and the business transcript. The reduction may ensure that the size of the content that may be provided to the LLM unit 210 does not violate the context window size. This holds true for all containers of legacy source code, including but not limited to, code functions, execution or workflow scripts, stored procedure scripts, data table definition files, and user interface definition files.

It should be noted that the <id> pointers listed in the technical transcript and business transcript may directly reference a corresponding node in the enriched semantic network 1100. The main purpose of using pointers is to minimize the physical size of the transcript files towards making the solution usable with most LLMs. Moreover, the process may be a safety mechanism. The one or more transcript files do not provide a comprehensive review of the underlying application and may only be used in a meaningful way by following the process.

The transcript generation unit 206 may send the one or more transcripts and list of capability names to the documentation generation unit 208.

Upon generating the transcripts, the method 700 may include generating, by the documentation generation unit 208, a documentation file based on the one or more transcripts utilizing the LLM, at step 710. The documentation generation unit 208 may receive the one or more transcripts and the list of capability names from the transcript generation unit 206. The documentation generation unit 208 may contain a set of predefined persona-specific prompt templates for a set of personas. Different personas may be defined, such as a developer, a data architect, a business analyst, a test SME, a requirements engineer, and the like.

An exemplary predefined persona-specific prompt template for business analyst may be as follows.
‘“CONTEXT:
{content}
Take on the role of a Business Analyst. Using the context that I provided you with as sole source and focusing on capability {name}, extract and present all business rules that are associated with this capability.
DETAILED INSTRUCTIONS
   1. Provide a unique Id for each Business Rule
   2. Provide a logical explanation for the business rule
   3. In additional to the logical rule, explain the rule using simple business language
   4. Cross-reference the original code function in which the rule executes.
   5. Cross correlate all data objects that are used in the rule evaluation.
   6. Present your output in html table.
   7. After the tables, provide a list containing a step-by-step overview of the information flow through the business function/capability”
Note: The {content} contains all 3 transcripts.

An exemplary predefined persona-specific prompt template for data architect may be as follows.
‘“CONTEXT:
{content}
1. Take on the role of a Data Architect. Using the context that I provided you with as sole source and focusing on capability {name}, generate a detailed and holistic data dictionary.
   DETAILED INSTRUCTIONS:
      A. Provide a unique Id for each Data element
      B. Distinguish between complex and elementary data elements
      C. Provide detailed metadata around each elementary data elements, including what the data element is used for in the context of the code snippet that is being analysed.
      D. Cross-reference complex data elements as well as business rules to which data element belongs to as separate columns.
      E. Sort data elements alphabetically
      F. Present your output in html table.
      G. Make sure to generate content only with charset uft-8
2. Using the context above create for me detailed data lineage assets for the three key data elements that are used in the business function/capability {name}. Show the genesis point and everywhere each of the three elements are read, written, or handed off to other elements throughout the entire code base. Present as three separate html tables.’”
Note: The {content} contains all 3 transcripts. The {name} contains list of capability names.

An exemplary predefined persona-specific prompt template for test analyst may be as follows.
‘“Using the content {content} as the sole source, can you explain to me the capability {name}. Please explain it to me from the point of view of a Quality Engineer or Test Analyst.
Detailed Instructions:
   1—As part of your explanation, create Pseudo code that corresponds to the code used for this capability. Then, define all unique logic code branches in this pseudo code. Finally, for each branch, define input field values that will drive to that branch as well as the expected result and represent this in table format called Test Cases.
   2. When using external references to create tests, include the links for these references as footnotes right before the Test Case table diagram.
Based on this {content} for the capability {name}, extract only the segments related to ‘Source code’,
   ‘apply valid syntax for PlantUML and develop a UML flow diagram and respond to me within’
   ‘the PlantUML structure, following the beginning and end of the tags “@startuml @enduml”.’
   ‘Guidance: Return only the “@startuml @enduml” and its content, ignore the \′\′\′ before and after
   ‘no need to respond to any explanations.””
Note: The {content} contains all 3 transcripts. The {name} contains list of capability names.

Along with the predefined persona-specific prompt template, a sub-prompt (i.e., the set of documentation instructions) may also be present. The sub-prompt may be automatically injected in the persona-specific prompt before sending to the LLM unit 210. By way of an example, an exemplary sub-prompt may be as follows.
‘“I will give you a TASK. It may be that the context I gave you does not have enough granular information for you, but I did place breadcrumb trails in the form of <id> statements. Each <id> refer to a node in a graph database that contains significantly more context. Hence, if you need more information from me to answer this question thoroughly, tell me the all <id>s that you would want more details around. I will provide you this back and then you can formulate your final response.
STRICT RESPONSE FORMAT: If you need additional information, you must respond ONLY with a JSON array of integers representing the IDs you need, for example: [3,5,20,21,300]. Your entire response must contain nothing else-no explanations, no text, no punctuation other than the array itself. If you include any additional content, this will break an automated workflow. Once I provide the details for these IDs, you can then proceed with your complete analysis.”
Here is the TASK: <Original persona-tailored prompt goes here>’”

The documentation generation unit 208 may send each of the set of predefined persona-specific prompt templates combined with the sub-prompt for each persona (i.e., the persona-specific documentation prompt) to the LLM unit 210. Further, the LLM unit 210 may generate, via the LLM, a documentation for each persona based on the transcripts.

The LLM unit 210 may return an array of node IDs (for example [110, 172, 111]) to the documentation generation unit 208. The additional context may be provided to the LLM unit 210 corresponding to the node IDs present in the array in order to answer the prompt. The documentation generation unit 208 may send the array of node IDs to the semantic network enrichment unit 204.

The semantic network enrichment unit 204 may obtain the additional context by means of a semantic query to the enriched semantic network 1100. The semantic query may return the rawCode property of the legacy source code snippet for each node for which the LLM unit 210 requested more details. The rawCode property may contain corresponding legacy application source code for the respective node type, for COBOL as an example, JCL script, COBOL paragraph source code, etc. The semantic query may be structured as follows (assuming Cypher language as an example, and using the exemplary three node ids of the array):
MATCH (n)
WHERE id(n) IN [110, 172, 111]
RETURN
   id (n) as nodeId,
   labels (n) as labels,
   properties (n) as properties

The semantic network enrichment unit 204 may send the additional context (such as rawCodes with array IDs) to the documentation generation unit 208. The documentation generation unit 208 may send the the additional context to the LLM unit 210.

The LLM Unit 210 may create the persona-specific knowledge nuggets based on the one or more transcripts and the additional context and may send the persona-specific knowledge nuggets to the documentation generation unit 208.

The documentation generation unit 208 may store the persona-specific knowledge nuggets in the database 214. Alternatively, the documentation generation unit 208 may provide the persona-specific knowledge nuggets to the user interface 110.

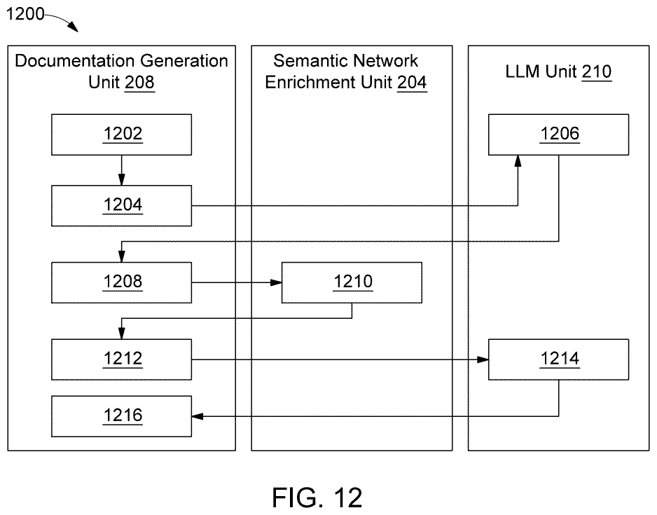

Referring now to FIG. 12, a detailed exemplary method 1200 for generating persona-specific documentation files of a legacy source code for a set of personas is depicted via a flowchart, in accordance with some embodiments of the present disclosure. The method 1200 may include reading, by the documentation generation unit 208, a knowledge nugget prompt (i.e., persona-specific documentation prompt) of a selected persona, at step 1202. In other words, a persona-specific documentation prompt may be selected from a set of persona-specific documentation prompts based on the selected persona. Further, the method 1200 may include passing, by the documentation generation unit 208, context (i.e., the one or more transcripts) and the persona-specific documentation prompt to the LLM unit 210, at step 1204. The persona-specific documentation prompt may include the predefined persona-specific prompt template and the set of documentation instructions. The set of documentation instructions may state that if the LLM may require more information for one or more nodes to answer the user query, the LLM is prompted to return an array of the node IDs of the one or more nodes based on the correlations determined based on the context.

Further, the method 1200 may include evaluating, by the LLM unit 210 via the LLM, the persona-specific documentation prompt using the context provided as the source and returning the array of node IDs for which the additional and more granular data may be required to the documentation generation unit 208, at step 1206. Further, the method 1200 may include sending, by the documentation generation unit 208, the array of node IDs to the semantic network enrichment unit 204, at step 1208. Further, the method 1200 may include constructing and executing, by the semantic network enrichment unit 204, a cypher query (for example, the semantic query) based on the array of node IDs and returning a JSON extract with the requested additional information to the documentation generation unit 208, at step 1210. The additional information may be raw source code (i.e., the legacy source code snippet) corresponding to each node ID in the array.

Further, the method 1200 may include sending, by the documentation generation unit 208, the JSON object to the LLM unit 210, at step 1212. Further, the method 1200 may include evaluating, by the LLM unit 210, the persona-specific documentation prompt again along with the requested additional context and constructing the final response (i.e. the documentation file), at step 1214. Further, the method 1200 may include receiving, by the documentation generation unit 208, the final response from the LLM unit 210 and sending, by the documentation generation unit 208, the final response to the database 214 or the user interface 110, at step 1216.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

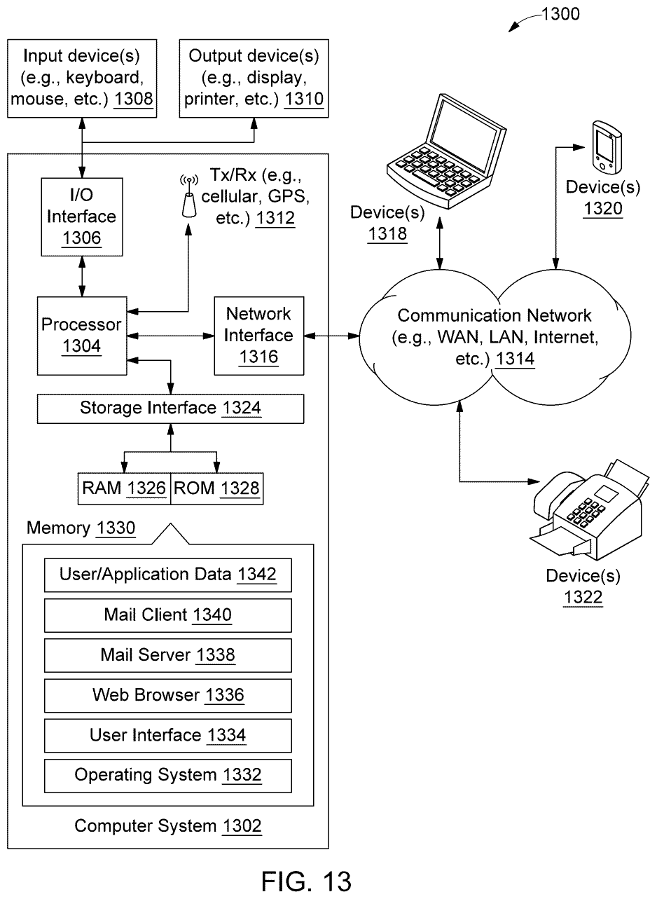

The disclosed methods and systems may be implemented on a conventional or a general-purpose computer system, such as a personal computer (PC) or server computer. Referring now to FIG. 13, a block diagram of an exemplary computer system 1302 for implementing embodiments consistent with the present disclosure is illustrated. Variations of the computer system 1302 may be used for implementing system 100 for building an ensemble model. The computer system 1302 may include a central processing unit (“CPU” or “processor”) 1304. The processor 1304 may include at least one data processor for executing program components for executing user-generated or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 1304 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

The processor 1304 may be disposed in communication with one or more input/output (I/O) devices via I/O interface 1306. The I/O interface 1306 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 1306, the computer system 1302 may communicate with one or more I/O devices. For example, the input device 1308 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 1310 may be a printer, fax machine, video display (e.g., cathode ray tube (CRT), liquid crystal display (LCD), light-emitting diode (LED), plasma, or the like), audio speaker, etc. In some embodiments, a transceiver 1312 may be disposed in connection with the processor 1304. The transceiver may facilitate various types of wireless transmission or reception. For example, the transceiver may include an antenna operatively connected to a transceiver chip (e.g., TEXAS INSTRUMENTS® WILINK WL1286®, BROADCOM® BCM4550IUB8®, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, the processor 1304 may be disposed in communication with a communication network 1316 via a network interface 1314. The network interface 1314 may communicate with the communication network 1316. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1316 may include, without limitation, a direct interconnection, local area network (LAN), wide area network (WAN), wireless network (e.g., using Wireless Application Protocol), the Internet, etc. Using the network interface 1314 and the communication network 1316, the computer system 1302 may communicate with devices 1318, 1320, and 1322. The devices 1318, 1320, and 1322 may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLER, NOOK® etc.), laptop computers, notebooks, gaming consoles (MICROSOFT® XBOX®, NINTENDO® DS®, SONY® PLAYSTATION®, etc.), or the like. In some embodiments, the computer system 1302 may itself embody one or more of the devices 1318, 1320, and 1322.

In some embodiments, the processor 1304 may be disposed in communication with one or more memory devices 1330 (e.g., a RAM 1326, a ROM 1328, etc.) via a storage interface 1324. The storage interface may connect to memory devices 1330 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, 12C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices 1330 may store a collection of program or database components, including, without limitation, an operating system 1332, user interface application 1334, web browser 1336, mail server 1338, mail client 1340, user/application data 1342 (e.g., legacy source code, input reference taxonomy, semantic networks, enriched semantic networks, transcripts, documentation files, various prompt templates, LLM data, and any other data variables or data records discussed in this disclosure), etc. The operating system 1332 may facilitate resource management and operation of the computer system 1302. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. The user interface application 1334 may facilitate display, execution, interaction, manipulation, or operation of program components through textual or graphical facilities. For example, user interfaces may provide computer interaction interface elements on a display system operatively connected to the computer system 1302, such as cursors, icons, check boxes, menus, scrollers, windows, widgets, etc. Graphical user interfaces (GUIs) may be employed, including, without limitation, APPLE® MACINTOSH® operating systems’ AQUA® platform, IBM® OS/2®, MICROSOFT® WINDOWS® (e.g., AERO®, METRO®, etc.), UNIX X-WINDOWS, web interface libraries (e.g., ACTIVEX®, JAVA® JAVASCRIPT®, AJAX®, HTML, ADOBE® FLASH®, etc.), or the like.

In some embodiments, the computer system 1302 may implement a web browser 1336 stored program component. The web browser may be a hypertext viewing application, such as MICROSOFT® INTERNET EXPLORER®, GOOGLE® CHROME® MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 1302 may implement a mail server 1338 stored program component. The mail server may be an Internet mail server such as MICROSOFT® EXCHANGER, or the like. The mail server may utilize facilities such as ASP, ActiveX, ANSI C++/C#, MICROSOFT .NET® CGI scripts, JAVA®, JAVASCRIPT®, PERL®, PHP®, PYTHON®, WebObjects, etc. The mail server may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 1302 may implement a mail client 1340 stored program component. The mail client may be a mail viewing application, such as APPLE MAIL®, MICROSOFT ENTOURAGE®, MICROSOFT OUTLOOK®, MOZILLA THUNDERBIRD®, etc.

In some embodiments, computer system 1302 may store user/application data 1342, such as the data, variables, records, etc. (e.g., the set of predictive models, the plurality of clusters, set of parameters (batch size, number of epochs, learning rate, momentum, etc.), accuracy scores, competitiveness scores, ranks, associated categories, rewards, threshold scores, threshold time, and so forth) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

Various embodiments provide method and system for generating customized documentation of legacy source codes. The disclosed method and system may create a semantic network based on a legacy source code through pattern identification of the legacy source code using a deterministic crawler. Further, the disclosed method and system may generate, via an LLM, an enriched semantic network from the semantic network based on an input reference taxonomy in response to a network enrichment prompt. The enriched semantic network may include a mapping between the semantic network and the input reference taxonomy. The network enrichment prompt may include the semantic network, the input reference taxonomy, and a set of network enrichment instructions. The input reference taxonomy may include a hierarchical arrangement of a plurality of source code functionalities. Further, the disclosed method and system may generate one or more transcripts for the enriched semantic network using a deterministic technique. Each of the one or more transcripts may be a natural language description of the enriched semantic network based on a predefined context. Further, the disclosed method and system may generate, via the LLM, a documentation file of the legacy source code for each of a set of personas based on the one or more transcripts in response to a persona-specific documentation prompt. The persona-specific documentation prompt may include the one or more transcripts, a predefined persona-specific prompt template, and a set of documentation instructions.

Thus, the disclosed techniques try to overcome the logical problem for generating customized documentation of legacy source codes. The techniques may cater to the requirement of generating persona-specific documentation in order to provide relevant information to each of the stakeholders corresponding to the specific role. The techniques may further provide guidance and support on all activities of the Software Development Life Cycle (SDLC), such as but are not limited to optimizing the legacy source code, performing impact analysis, and managing data lineage. The techniques may further ensure availability of the necessary resources to the team members and assistance to effectively carry out the assigned tasks. The techniques may further enhance collaboration within the team and the organization and may ensure streamline workflows. The techniques may further improve the efficiency, effectiveness of maintaining the legacy source code and evolving the legacy source code. The techniques may further help in managing current limitations on the context window size for many LLMs by not overwhelming the LLMs with a large body of context as would be the case for large legacy applications.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has a described method and system for generating customized documentation of legacy source codes. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for generating customized documentation of legacy source codes, the method comprising:
creating, by a processor, a semantic network based on a legacy source code through pattern identification of the legacy source code using a deterministic crawler;
generating, by the processor via a Large Language Model (LLM), an enriched semantic network from the semantic network based on an input reference taxonomy in response to a network enrichment prompt, wherein the enriched semantic network comprises a mapping between the semantic network and the input reference taxonomy, wherein the network enrichment prompt comprises the semantic network, the legacy source code, the input reference taxonomy, and a set of network enrichment instructions, and wherein the input reference taxonomy comprises a hierarchical arrangement of a plurality of source code functionalities;
generating, by the processor, one or more transcripts for the enriched semantic network using a deterministic technique, wherein each of the one or more transcripts is a natural language description of the enriched semantic network based on a predefined context; and
generating, by the processor via the LLM, a documentation file of the legacy source code for each of a set of personas based on the one or more transcripts in response to a persona-specific documentation prompt, wherein the persona-specific documentation prompt comprises the one or more transcripts, a predefined persona-specific prompt template, and a set of documentation instructions.

2. The method of claim 1, wherein creating the semantic network comprises:
receiving the legacy source code from one of a user interface or a database;
identifying a set of nodes and a set of properties associated with each of the set of nodes, through pattern identification of the legacy source code using the deterministic crawler, wherein each of the set of nodes corresponds to a code snippet in the legacy source code, and wherein the code snippet is one of the set of properties;
determining a set of edges connecting the set of nodes through pattern identification of the set of nodes using the deterministic crawler, wherein each of the set of edges is indicative of a relationship between two of the set of nodes; and
creating the semantic network from the set of nodes, the set of properties for each of the set of nodes, and the set of edges.

3. The method of claim 2, wherein generating, via the LLM, the enriched semantic network comprises:
for each of one or more nodes of the set of nodes, retrieving the code snippet and remaining of the set of properties from the semantic network;
preprocessing the code snippet corresponding to each of the one or more of the set of nodes;
receiving the input reference taxonomy from a user interface, wherein the input reference taxonomy comprises a set of keywords for each of the source code functionalities, and wherein the hierarchical arrangement comprises a set of specificity levels; and
creating the network enrichment prompt using the semantic network, the code snippet for each of the one or more nodes of the set of nodes, the input reference taxonomy, and the set of network enrichment instructions.

4. The method of claim 3, further comprising:
inputting the network enrichment prompt to the LLM;
for each of the set of nodes, comparing, via the LLM, the preprocessed code snippet with the set of keywords for each of a plurality of high specificity level functionalities from the plurality of source code functionalities upon receiving the network enrichment prompt;
identifying, via the LLM, one or more relevant source code functionalities from the plurality of high specificity level functionalities for each of the set of nodes based on the comparing; and
mapping, via the LLM, each of the one or more relevant source code functionalities to at least one of the set of nodes of the semantic network to obtain the enriched semantic network.

5. The method of claim 2, wherein generating the documentation file comprises:
for each persona of the set of personas,
generating the persona-specific documentation prompt using the one or more transcripts, the predefined persona-specific prompt template for the persona, and the set of documentation instructions;
inputting the persona-specific documentation prompt to the LLM;
identifying, via the LLM, one or more of the set of nodes for an additional context requirement for documentation file generation;
retrieving a code snippet of the legacy source code corresponding to each of the one or more of the set of nodes from the enriched semantic network through a semantic query; and
generating, via the LLM, the documentation file of the legacy source code for the persona in accordance with the predefined persona-specific prompt template and a set of documentation instructions, based on the one or more transcripts and the code snippet corresponding to each of the one or more of the set of nodes.

6. A system for generating customized documentation of legacy source codes, the system comprising:
a processor; and
a memory communicatively coupled to the processor, wherein the memory stores processor instructions, which when executed by the processor, cause the processor to:
create a semantic network based on a legacy source code through pattern identification of the legacy source code using a deterministic crawler;
generate, via a Large Language Model (LLM), an enriched semantic network from the semantic network based on an input reference taxonomy in response to a network enrichment prompt, wherein the enriched semantic network comprises a mapping between the semantic network and the input reference taxonomy, wherein the network enrichment prompt comprises the semantic network, the legacy source code, the input reference taxonomy, and a set of network enrichment instructions, and wherein the input reference taxonomy comprises a hierarchical arrangement of a plurality of source code functionalities;
generate one or more transcripts for the enriched semantic network using a deterministic technique, wherein each of the one or more transcripts is a natural language description of the enriched semantic network based on a predefined context; and
generate, via the LLM, a documentation file of the legacy source code for each of a set of personas based on the one or more transcripts in response to a persona-specific documentation prompt, wherein the persona-specific documentation prompt comprises, the one or more transcripts, a predefined persona-specific prompt template, and a set of documentation instructions.

7. The system of claim 6, wherein to create the semantic network, the processor instructions, on execution, cause the processor to:
receive the legacy source code from one of a user interface or a database;
identify a set of nodes and a set of properties associated with each of the set of nodes, through pattern identification of the legacy source code using the deterministic crawler, wherein each of the set of nodes corresponds to a code snippet in the legacy source code, and wherein the code snippet is one of the set of properties;
determine a set of edges connecting the set of nodes through pattern identification of the set of nodes using the deterministic crawler, wherein each of the set of edges is indicative of a relationship between two of the set of nodes; and
create the semantic network from the set of nodes, the set of properties for each of the set of nodes, and the set of edges.

8. The system of claim 7, wherein to generate, via the LLM, the enriched semantic network, the processor instructions, on execution, cause the processor to:
for each of one or more nodes of the set of nodes, retrieve the code snippet and remaining of the set of properties from the semantic network;
preprocess the code snippet corresponding to each of the one or more of the set of nodes;
receive the input reference taxonomy from a user interface or the database, wherein the input reference taxonomy comprises a set of keywords for each of the source code functionalities, and wherein the hierarchical arrangement comprises a set of specificity levels; and
create the network enrichment prompt using the semantic network, the code snippet for each of the one or more nodes of the set of nodes, the input reference taxonomy, and the set of network enrichment instructions.

9. The system of claim 8, wherein the processor instructions, on execution, further cause the processor to:
input the network enrichment prompt to the LLM;
for each of the set of nodes, compare, via the LLM, the preprocessed code snippet with the set of keywords for each of a plurality of high specificity level functionalities from the plurality of source code functionalities upon receiving the network enrichment prompt;
identify, via the LLM, one or more relevant source code functionalities from the plurality of high specificity level functionalities for each of the set of nodes based on the comparing; and
map, via the LLM, each of the one or more relevant source code functionalities to at least one of the set of nodes of the semantic network to obtain the enriched semantic network.

10. The system of claim 7, wherein to generate the documentation file, the processor instructions, on execution, cause the processor to:
for each persona of the set of personas,
generate the persona-specific documentation prompt using the one or more transcripts, the predefined persona-specific prompt template for the persona, and the set of documentation instructions;
input the persona-specific documentation prompt to the LLM;
identify, via the LLM, one or more of the set of nodes for an additional context requirement for documentation file generation;
retrieve a code snippet of the legacy source code corresponding to each of the one or more of the set of nodes from the enriched semantic network through a semantic query; and
generate, via the LLM, the documentation file of the legacy source code for the persona in accordance with the predefined persona-specific prompt template and a set of documentation instructions, based on the one or more transcripts and the code snippet corresponding to each of the one or more of the set of nodes.

11. A non-transitory computer-readable medium storing computer-executable instructions for generating customized documentation of legacy source codes, the computer-executable instructions configured for:
creating a semantic network based on a legacy source code through pattern identification of the legacy source code using a deterministic crawler;
generating, via a Large Language Model (LLM), an enriched semantic network from the semantic network based on an input reference taxonomy in response to a network enrichment prompt, wherein the enriched semantic network comprises a mapping between the semantic network and the input reference taxonomy, wherein the network enrichment prompt comprises the semantic network, the legacy source code, the input reference taxonomy, and a set of network enrichment instructions, and wherein the input reference taxonomy comprises a hierarchical arrangement of a plurality of source code functionalities;
generating one or more transcripts for the enriched semantic network using a deterministic technique, wherein each of the one or more transcripts is a natural language description of the enriched semantic network based on a predefined context; and
generating, via the LLM, a documentation file of the legacy source code for each of a set of personas based on the one or more transcripts in response to a persona-specific documentation prompt, wherein the persona-specific documentation prompt comprises, the one or more transcripts, a predefined persona-specific prompt template, and a set of documentation instructions.

12. The non-transitory computer-readable medium of claim 11, wherein for creating the semantic network, the computer-executable instructions are configured for:
receiving the legacy source code from one of a user interface or a database;
identifying a set of nodes and a set of properties associated with each of the set of nodes, through pattern identification of the legacy source code using the deterministic crawler, wherein each of the set of nodes corresponds to a code snippet in the legacy source code, and wherein the code snippet is one of the set of properties;
determining a set of edges connecting the set of nodes through pattern identification of the set of nodes using the deterministic crawler, wherein each of the set of edges is indicative of a relationship between two of the set of nodes; and
creating the semantic network from the set of nodes, the set of properties for each of the set of nodes, and the set of edges.

13. The non-transitory computer-readable medium of claim 12, wherein for generating, via the LLM, the enriched semantic network, the computer-executable instructions are configured for:
for each of one or more nodes of the set of nodes, retrieving the code snippet and remaining of the set of properties from the semantic network;
preprocessing the code snippet corresponding to each of the one or more of the set of nodes;
receiving the input reference taxonomy from a user interface or the database, wherein the input reference taxonomy comprises a set of keywords for each of the source code functionalities, and wherein the hierarchical arrangement comprises a set of specificity levels; and
creating the network enrichment prompt using the semantic network, the code snippet for each of the one or more nodes of the set of nodes, the input reference taxonomy, and the set of network enrichment instructions.

14. The non-transitory computer-readable medium of claim 13, wherein the computer-executable instructions are further configured for:
inputting the network enrichment prompt to the LLM;
for each of the set of nodes, comparing, via the LLM, the preprocessed code snippet with the set of keywords for each of a plurality of high specificity level functionalities from the plurality of source code functionalities upon receiving the network enrichment prompt;
identifying, via the LLM, one or more relevant source code functionalities from the plurality of high specificity level functionalities for each of the set of nodes based on the comparing; and
mapping, via the LLM, each of the one or more relevant source code functionalities to at least one of the set of nodes of the semantic network to obtain the enriched semantic network.

15. The non-transitory computer-readable medium of claim 12, wherein for generating the documentation file, the computer-executable instructions are configured for:
for each persona of the set of personas,
generating the persona-specific documentation prompt using the one or more transcripts, the predefined persona-specific prompt template for the persona, and the set of documentation instructions;
inputting the persona-specific documentation prompt to the LLM;
identifying, via the LLM, one or more of the set of nodes for an additional context requirement for documentation file generation;
retrieving a code snippet of the legacy source code corresponding to each of the one or more of the set of nodes from the enriched semantic network through a semantic query; and
generating, via the LLM, the documentation file of the legacy source code for the persona in accordance with the predefined persona-specific prompt template and a set of documentation instructions, based on the one or more transcripts and the code snippet corresponding to each of the one or more of the set of nodes.
